(19) United States
(12) Patent Application Publication
(10) Pub. No.: US 2019/0168252 A1
(43) Pub. Date: Jun. 6, 2019

(54) MULTI-COMPONENT FLEXIBLE PACK DISPENSING MANIFOLD AND SYSTEM

(71) Applicant: NORDSON CORPORATION, Westlake, OH (US)

(72) Inventor: Robert William Springhorn, Cream Ridge, NJ (US)

(21) Appl. No.: 16/268,404

(22) Filed: Feb. 5, 2019

Related U.S. Application Data
(62) Division of application No. 15/690,619, filed on Aug. 30, 2017.
(60) Provisional application No. 62/381,627, filed on Aug. 31, 2016.

(51) Int. Cl. B05C 17/005

(52) U.S. Cl. CPC B05C 17/00586; B05C 17/00583; B05C 17/00576; B05C 17/00553; B05C 17/00513

(57) ABSTRACT

A dispensing system includes a support structure and a container. The support structure includes a base and an extension arm having a first end coupled to the base and a second end spaced from the first end, and a gate coupled to the second end of the extension arm. The extension arm defines a recess or pocket between the first end and the second end. The container is coupled to the support structure and has a pin extending from an outer surface. The recess or pocket receives the pin within.

### CROSS REFERENCE TO RELATED APPLICATIONS

This application is a divisional of U.S. patent application Ser. No. 15/690,619, filed Aug. 30, 2017, and published as U.S. Patent App. Pub. No. 2018/0056324 on Mar. 1, 2018, which claims the benefit of U.S. Provisional Patent App. No. 62/381,627, filed Aug. 31, 2016, which is hereby incorporated by reference.

### TECHNICAL FIELD

This disclosure relates generally to a dispensing system having a piercing member for opening a collapsible container.

### BACKGROUND

Dispensing systems are commonly used for dispensing one or more fluids from containers. For example, some dispensing systems use so-called “sausage pack” containers, which are flexible and collapsible fluid containers. This type of collapsible container is generally cylinder shaped, and includes a fluid enclosed by a flexible membrane. Collapsible containers are generally sealed until they are ready to be used, at which point it is necessary to puncture the membrane. As the fluid is extracted from the container, the membrane may collapse to occupy a smaller volume than when it was full.

In one current system, the collapsible container is pre-assembled with a manifold. Just prior to use, the collapsible container is punctured and the fluid stored within is dispensed. This system generally requires extra handling related to the assembly and packaging, which requires extra care and risk. Additionally, the stored fluid often leaks and/or prematurely hardens within the container, as these systems are often susceptible to premature puncture.

To overcome these concerns, in other current systems, the container is introduced to the manifold just prior to dispensing. This results in less handling of the containers throughout distribution and use. For example, U.S. Pat. No. 5,184,757 describes a system having collapsible containers inserted into cylindrical barrels with a manifold introduced just prior to dispensing. The manifold is placed on an end of the cylindrical barrels and locked into place by a swing gate that is pivotable relative to the cylindrical barrels. Pistons are inserted into the barrels to extract the fluid from the collapsible containers. However, these systems often require specific dispensers and additional manual steps for opening the container prior to loading the dispensing system. Additionally, the force applied to the collapsible containers within the cylindrical barrels is also applied to the swing gate and the pivoting members.

Thus, an improved and/or simplified dispensing system for dispensing fluids is desired to increase the effectiveness and life expectancy of the system while minimizing leakage and assembly delay time.

### SUMMARY

An aspect of the present disclosure provides a manifold assembly. The manifold assembly includes a manifold head and at least one piercing member. The manifold head includes a cap portion and a wall portion. The cap portion has an upper surface, a lower surface, and an inner edge that extends at least partially in a circumferential direction. The inner edge defines an opening that extends from the upper surface to the lower surface. The wall portion is coupled to the lower surface of the cap portion and has an inner wall surface that defines a channel. The at least one piercing member is coupled to the manifold head and extends in the circumferential direction along the inner edge of the cap portion and into the channel.

Another aspect of the present disclosure provides a dispensing system. The dispensing system includes a support structure and a container. The support structure includes a base, an extension arm, and a gate. The extension arm has a first end coupled to the base and a second end spaced from the first end. The extension arm defines a recess between the first end and the second end. The gate is coupled to the second end of the extension arm. The container is coupled to the support structure and has a pin extending from an outer surface. The recess is configured to receive the pin within.

Another aspect of a dispensing system includes a support structure and a container. The support structure includes a base, an extension arm, and a gate. The extension arm has a first end coupled to the base and a second end spaced from the first end. The extension arm defines a pocket between the first end and the second end. The gate is coupled to the second end of the extension arm. The container is coupled to the support structure and has a pin extending from an outer surface. The pocket is configured to receive the pin within.

Another aspect of a dispensing system includes a support structure and a container. The support structure includes a base, an extension arm, and a gate. The extension arm has a first end coupled to the base and a second end opposing the first end. The gate is coupled to the second end of the extension arm. The container is coupled to the support structure and includes a rib extending along an outer surface of the container. The extension arm is configured to support the rib of the container.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there is shown in the drawings illustrative embodiments of the disclosure. It should be understood, however, that the application is not limited to the precise arrangements and instrumentalities shown. In the drawings:

FIG. 1 illustrates an exploded perspective view of a fluid dispensing system.

FIG. 2 illustrates an exploded perspective view of another implementation of a fluid dispensing system.

FIG. 3A illustrates a perspective view of the assembled fluid dispensing system shown in FIG. 1.

FIG. 3B illustrates a perspective cross sectional view of the fluid dispensing system shown in FIG. 3A taken along line 3-3.

FIG. 4 illustrates a cross section of the containers and the manifold shown in FIG. 3.

FIG. 5 illustrates a perspective view of a manifold assembly.

FIGS. 6 through 9 illustrate alternative implementations of manifold assemblies.

FIG. 10 illustrates an alternative implementation of a fluid dispensing system.

FIG. 11 illustrates another alternative implementation of a fluid dispensing system.

### DETAILED DESCRIPTION

The disclosure relates generally to a fluid dispensing system for dispensing fluid from collapsible containers. The fluid dispensing system includes a container and manifold that has at least one piercing member coupled thereto. When a collapsible container is slid within the container, the at least one piercing member may pierce a membrane of the collapsible container. A fluid stored within the collapsible container then flows through the manifold.

Certain terminology is used in the description for convenience only and is not limiting. The words “proximal” and “distal” generally refer to positions or directions toward and away from, respectively, an individual operating a fluid dispensing assembly 100. The words “longitudinal”, “radial,” and “transverse” designate directions in the drawings to which reference is made. The term “substantially” is intended to mean considerable in extent or largely but not necessarily wholly that which is specified. The terminology includes the above-listed words, derivatives thereof and words of similar import.

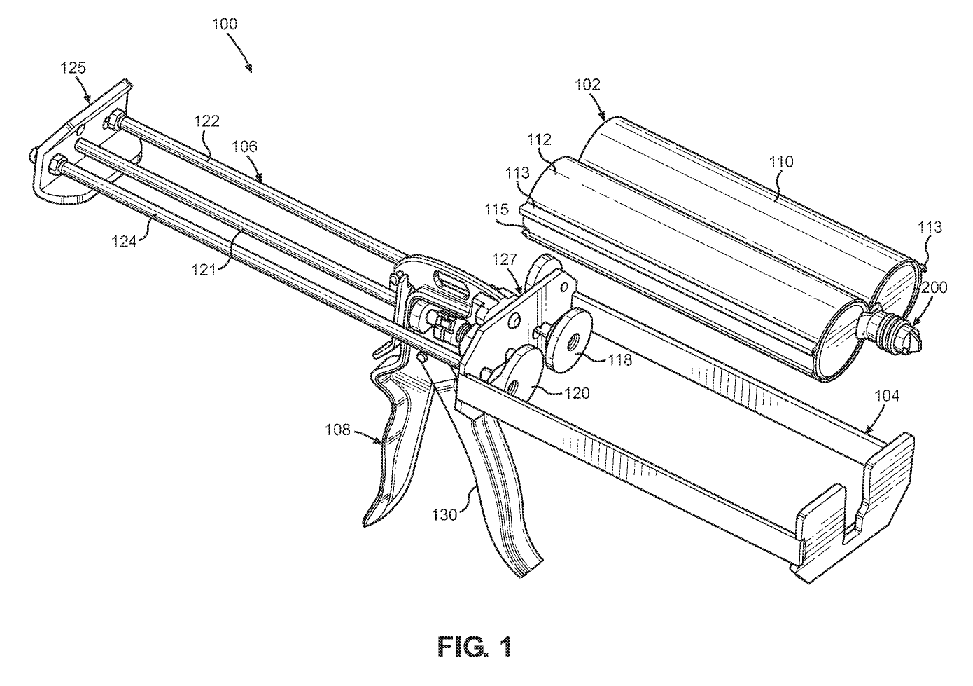

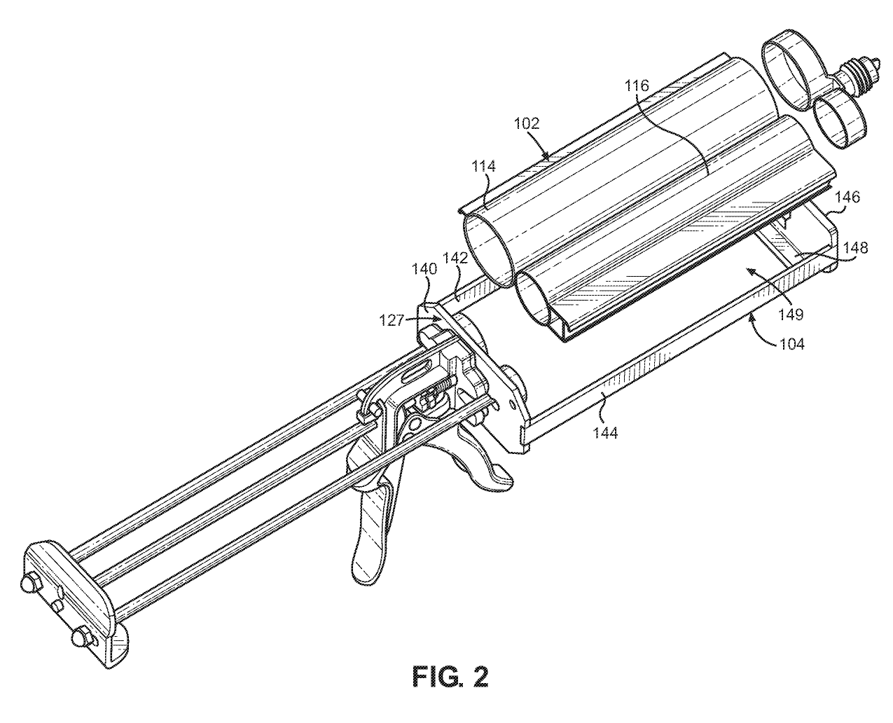

FIGS. 1-3 illustrate perspective views of the fluid dispensing assembly 100. The fluid dispensing assembly 100 includes containers 102, a support structure 104, a plunger assembly 106, an actuator 108, and a manifold assembly 200. The containers 102 may include cylindrical barrels 110 and 112 (FIG. 1) or cylindrical barrels 114 and 116 (FIG. 2) being parallel relation. The containers 102 may include barrels having varying size diameters, for example, a diameter of cylindrical barrel 116 may be smaller than a diameter of cylindrical barrel 114. Alternatively, the containers 102 may include barrels having substantially similar diameters, for example, a diameter of cylindrical barrel 110 may be substantially the same as a diameter of cylindrical barrel 112. The containers 102 may include ribs 113 and optional retention ribs 115 that extend along an outer surface from a distal end to a proximal end of the containers 102. The containers 102 may be configured to be supported by and fit within the support structure 104 as further described below.

Each of the containers 102 may be configured to hold a collapsible container (not shown) within. As used herein, the term “collapsible container” refers to the type of flexible and collapsible fluid containers which are known in the art as “sausage packs”. It will also be appreciated that the collapsible container is also applicable to other types of rigid or flexible containers that have a pierceable component that must be pierced before fluid can be dispensed from the container.

The collapsible container may include a flexible and collapsible, yet resilient, membrane. The membrane is configured to be pierced in order to provide access to the material contained within the membrane. The collapsible containers are generally cylindrical in shape and have a diameter and length slightly less than the containers 102. Each of the collapsible containers positioned within the containers 102 may be similar or different, and are typically different so that a mixture of the two fluids forms a composite fluid.

The plunger assembly 106 may include a first plunger 118, a second plunger 120, and a thrust rod 121. Each of the first and second plungers 118 and 120 may be configured to slide within their respective cylindrical barrel 110 and 112. Each of the first and second plungers 118 and 120 is coupled to a distal end of the corresponding first and second plunger rod 122 and 124. Each of the first and second plunger rods 122 and 124 extend from a proximal end 125 of the fluid dispensing assembly 100 through a proximal end 127 of the support structure 104.

The actuator 108 acts to effect concurrent movement of the first and second plungers 118 and 120 to advance or retract the plungers. The actuator 108 may be operatively coupled to the thrust rod 121 of the plunger assembly 106, such that actuation of a trigger 130 of the actuator 108 advances the thrust rod 121 in the proximal direction into the support structure 104. The advancement of the thrust rod 121 causes each of the first and second plungers 118 and 120 to advance into the support structure 104. The actuator 108 may comprise a manually driven gun, as shown in the figures, a pneumatically driven gun, or other actuation mechanism configured to drive the first and second plungers 118 and 120.

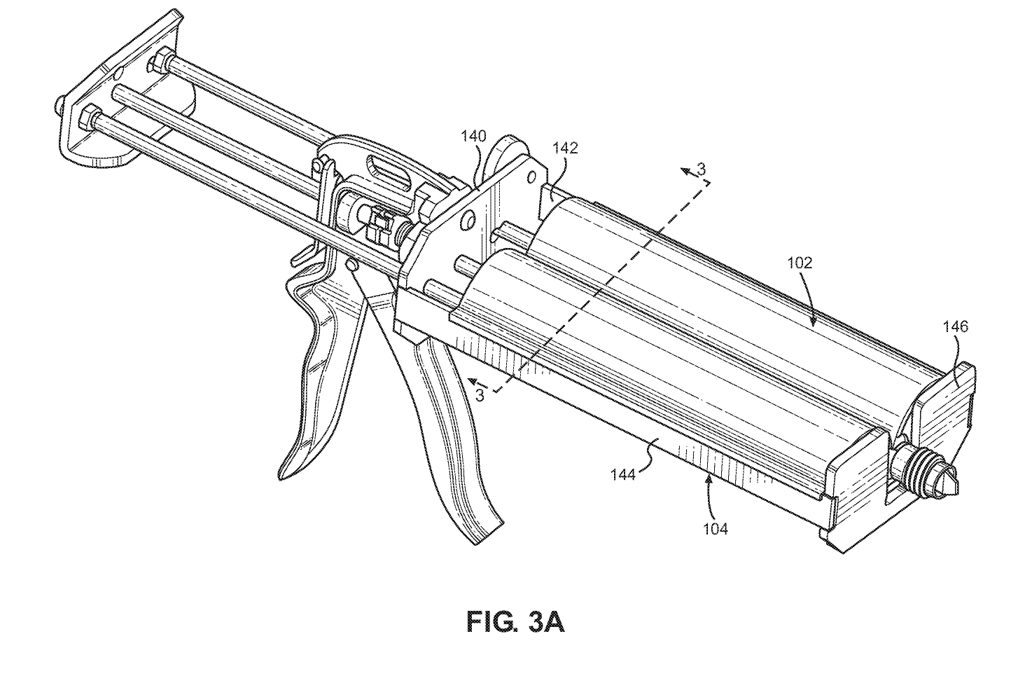

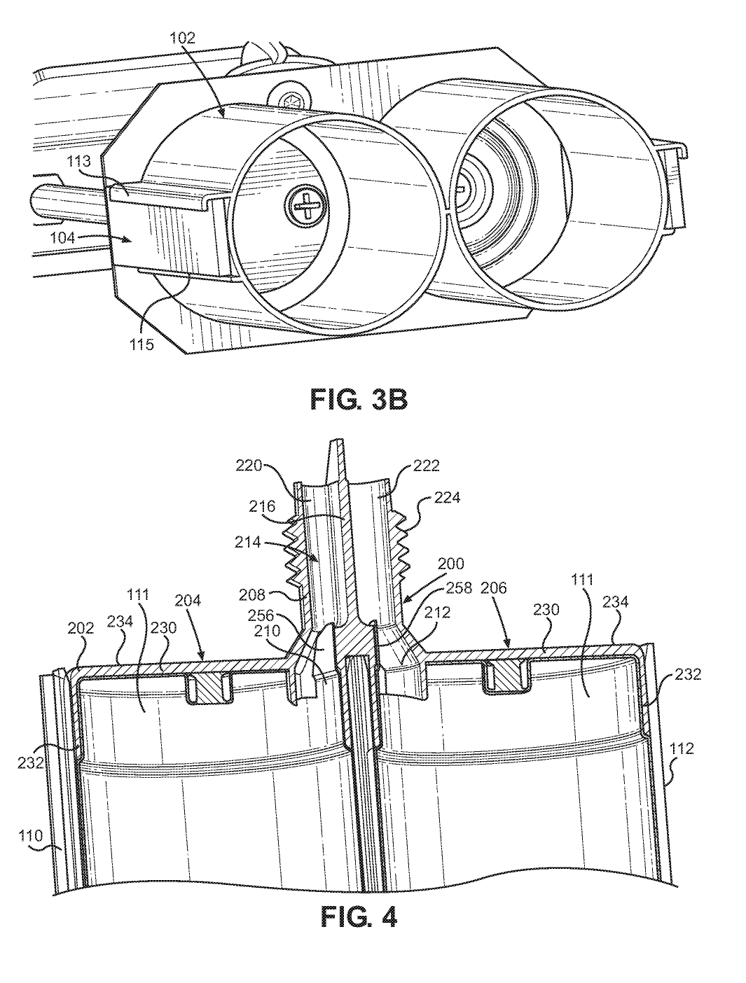

Referring to FIGS. 2, 3A and 3B, the support structure 104 includes a base 140, a first extension arm 142, a second extension arm 144, and a gate 146. The base 140 and the gate 146 are positioned at opposing ends of the support structure 104, the base 140 being positioned at the proximal end 127 and the gate 146 being positioned at a distal end. Each of the first and second extension arms 142 and 144 include a first end coupled to the base 140 at the proximal end 127 of the support structure 104, and a second end coupled to the gate 146 at the distal end of the support structure 104. In an aspect, the first and second extension arms 142 and 144 may be welded to the gate 146 and the base 140. The first and second extension arms 142 and 144 and the base 140 and gate 146 define an opening 149 that extends through the support structure 104. The size of the opening 149 is such that the containers 102 may fit within.

With reference to FIG. 3B, which illustrates a perspective cross-sectional view of the fluid dispensing assembly 100 taken along line 3-3 of FIG. 3A, the ribs 113 of the containers 102 may be supported by the first and second extension arms 142 and 144. A benefit of the ribs 113 and the optional retention ribs 115 is that they may rest and/or snap onto an existing unmodified dispenser assembly unit that is currently in use in the field. For example, the containers 102 may only include ribs 113 such that the containers 102 simply rest on support structure 104, or the containers 102 may have the ribs 113 and the optional retention ribs 115 causing the containers 102 to snap onto the support structure 104.

The base 140 may define a first and second plunger opening (not labeled) configured to allow the first and second plunger rods 122 and 124 to slide therethrough, respectively. The base 140 may also define a screw opening (not labeled) configured to allow the thrust rod 121 to slide therethrough. The base 140 may be coupled to the actuator 108.

The gate 146 may include a base gate member 148 that extends from the gate 146 towards the proximal end of the support structure 104. The base gate member 148 may be positioned at a bottommost end of the gate 146 and configured to support the containers 102 when the containers 102 are positioned within the support structure 104.

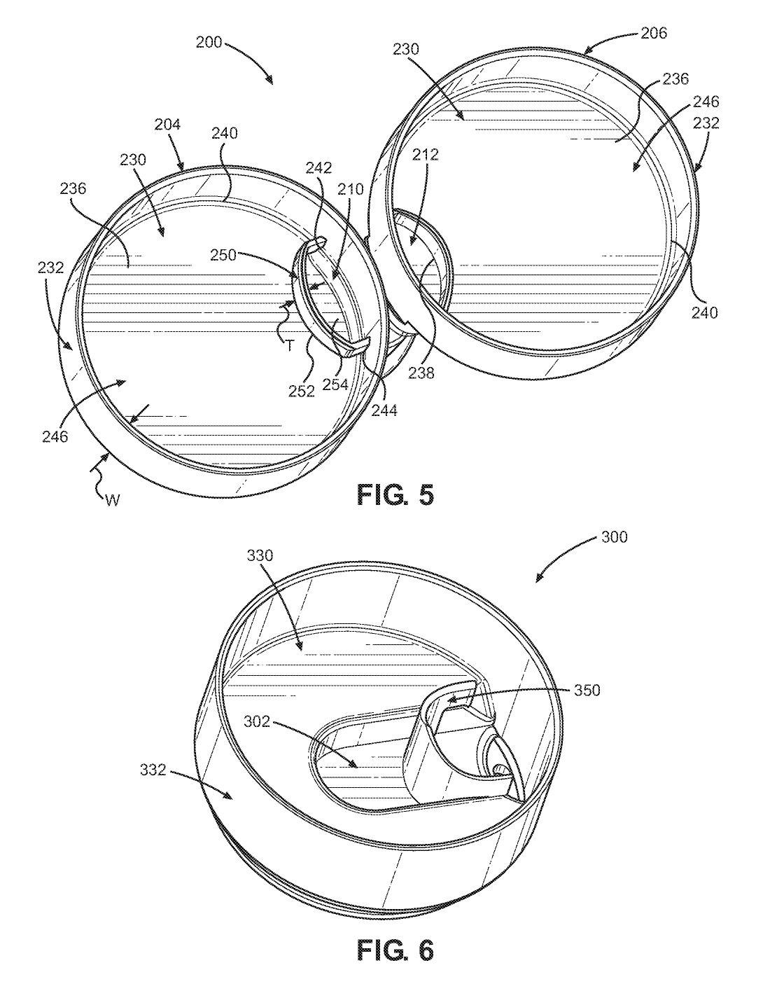

FIGS. 4 and 5 illustrate a cross section of the containers 102 positioned within the manifold assembly 200, and a bottom view of the manifold assembly 200, according to aspects of this disclosure. The manifold assembly 200 may be coupled to a distal end of the containers 102. The manifold assembly 200 includes a manifold head 202 having a first cap section 204, a second cap section 206, and a neck 208. The first and second cap sections 204 and 206 have a generally tubular shape, but closed on one end, and are configured to receive a portion of the first and second barrels 110 and 112, respectively, therein. As shown, first ends 111 of the first and second barrels 110 and 112 are received within the first and second cap sections 204 and 206.

A first opening 210 is formed in the first cap section 204 adjacent the first end 111 of the first barrel 110. Similarly, a second opening 212 is formed in the second cap section 206 adjacent the first end 111 of the second barrel 112. The first and second openings 210 and 212 are configured to accommodate the flow of fluids from the first and second barrels 110 and 112, respectively, to neck 208 of the manifold assembly 200.

The neck 208 of the manifold assembly 200 is positioned generally centrally with respect to the first and second cap sections 204 and 206, and extends away therefrom towards a distal end of the manifold assembly 200. The neck 208 includes a bore 214, which is divided by a diametrically extending internal partition 216 that extends the length of the bore 214. The partition 216 divides the bore 214 into a first passageway 220 and a second passageway 222. The first passageway 220 fluidly communicates with the first opening 210 in the first cap section 204, and the second passageway 222 fluidly communicates with the second opening 212 in the second cap section 206. The first and second passageways 220 and 222 are configured to accommodate the flow of fluids from the first and second barrels 110 and 112, respectively.

The neck 208 may also include an outer threaded portion 224 that is adjacent to the distal end of the manifold assembly 200. The threaded portion 224 may be configured to engage a threaded portion of, for example, a mixing nozzle (not shown).

Each of the first and second cap sections 204 and 206 of the manifold head 202 include a cap portion 230 and a wall portion 232. The cap portion 230 includes an upper surface 234, a lower surface 236 opposing the upper surface 234, an inner edge 238, and an outer edge 240. The inner edge 238 defines the first and second openings 210 and 212 formed in the first and second cap sections, respectively, which extend from the lower surface 236 to the upper surface 234.

The outer edge 240 extends about each of the first and second cap sections 204 and 206. The outer edge 240 may define an outer perimeter of the cap portion 230. The inner edge 238 extends from a first end 242 of the outer edge 240 to a second end 244 of the outer edge 240. The inner edge 238 may extend at least partially in a circumferential direction. For example, the inner edge 238 may extend in an 180° arc from the first end 242 to the second end 244.

The wall portion 232 may be coupled to the lower surface 236 of the cap portion 230 and extend about the outer edge 240 in the distal direction by a wall distance W. The wall portion 232 defines a channel 246 that extends from the lower surface 236 of the cap portion 230 to the proximal end of the manifold head 202. The channel 246 is configured to receive collapsible containers within. When the collapsible containers are positioned within the channel 246, a primary seal is formed between an outer diameter of the collapsible container and an inner diameter of the wall portion 232. Additionally, an outer diameter of the wall portion 232 may have a substantially similar size as an inner diameter of the containers 102, such that the containers 102 may slide around the outer diameter of the wall portion 232 to create a secondary seal between them.

A piercing member 250 may be coupled to the manifold head 202 along the inner edge 238 of the cap portion 230. The piercing member 250 may extend into the channel 246, such that when a collapsible container is positioned within the channel 246, the piercing member 250 may engage and pierce the membrane of the container.

The piercing member 250 may extend along the inner edge 238 in the circumferential direction. In an aspect, the piercing member 250 may extend along the entire inner edge 238, such that the piercing member 250 extends from the first end 242 of the outer edge 240 to a second end 244 of the outer edge 240.

The piercing member 250 includes a base 252 and a tip 254. The base 252 may be coupled to the lower surface 236 of the manifold head 202, for example, to the inner edge 238. The base 252 may have a curvilinear shape when viewed from the proximal direction. The base 252 may have a substantially similar shape as the inner edge 238 of the cap portion 230. For example, if the inner edge 238 extends in a 180° arc, the base 252 may also extend in a 180° arc.

The tip 254 may be spaced from the base 252 in the proximal direction by a tip distance T, such that the piercing member 250 is substantially perpendicular to the lower surface 236 of the manifold head 202. Alternatively, the piercing member 250 may be angularly offset from the lower surface 236.

In an aspect, the tip distance T is less than the wall distance W, such that the tip 254 is within the channel 246 of the wall portion 232. This configuration may help prevent the tip 254 from being damaged during transportation, assembly, or other use.

FIG. 6 illustrates an alternative aspect of a manifold assembly 300. The manifold assembly 300 includes a cap portion 330 and a wall portion 332 configured substantially similarly to the cap portion 230 and the wall portion 232 of the manifold assembly 200. The manifold assembly 300 includes an inner channel 302 formed in a lower surface 336 of the cap portion 330. The inner channel 302 is configured to receive a piercing member 350 within. Sidewalls of the inner channel 302 may be adjacent to an inner circumference of the piercing member 350, or alternatively, the piercing member 350 may be fully contained within the inner channel 302. The piercing member 350 may be configured substantially similarly to the piercing member 250 described above.

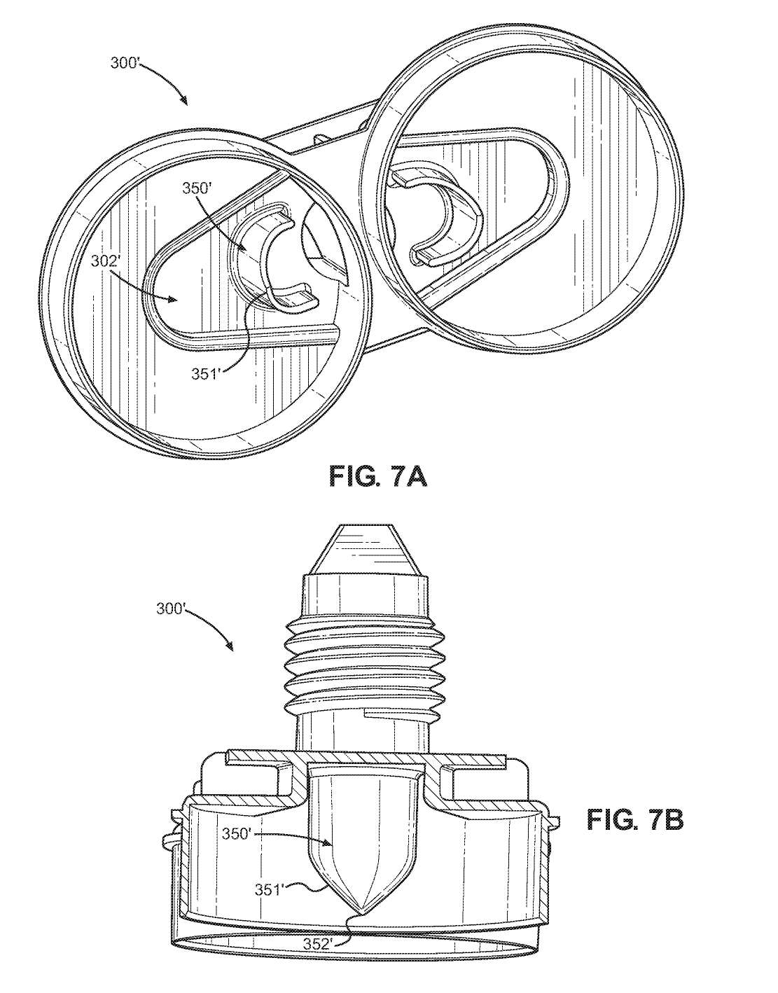

FIGS. 7A and 7B illustrate another alternative aspect of a manifold assembly 300′. The manifold assembly 300′ includes a piercing member 350′ that is fully contained within an inner channel 302′. The piercing member 350′ includes a tip 352′ and a blade edge 351′ that extends along a proximal end of the piercing member 350′. In a preferred aspect, the blade edge 351′ forms a knife edge having a spear point shape (as illustrated in FIG. 7B) when viewed from a side, such that the blade edge 351′ has a symmetrical curve on either side of the tip 352′. In alternative aspects, the blade edge 351′ may include the following shapes: straight back, drop point, curved trailing point, clip point, straight clip point, or still other shapes.

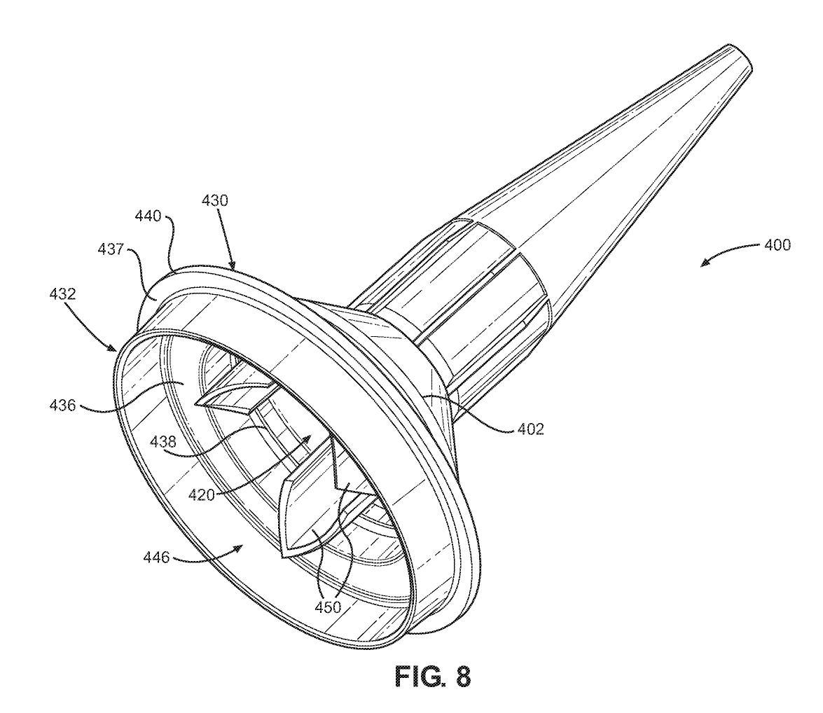

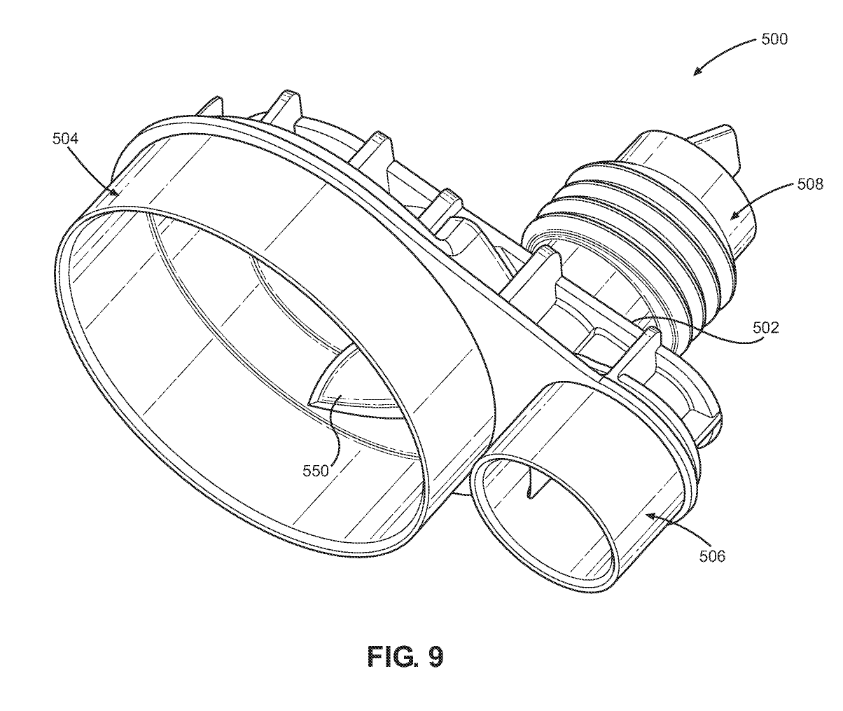

FIGS. 8 and 9 illustrate alternate aspects of manifold assemblies 400 and 500. The manifold assembly 400 includes a manifold head 402 that has a cap portion 430 and a wall portion 432. The wall portion 432 may be configured substantially similarly to the cap portions 230 and 330 of the manifold assemblies 200 and 300. The cap portion 430 includes an upper surface (not visible), a lower surface 436 opposing the upper surface, an inner edge 438, and an outer edge 440. The inner edge 438 defines an opening 410 that extends from the lower surface 436 to the upper surface of the cap portion 430. The opening may open to a passageway 420, similar to how the first and second openings 210 and 212 open to the first and second passageways 220 and 222 of the manifold assembly 200. In an aspect, the opening 410 may be substantially circular.

The outer edge 440 extends about the cap portion 430, and may define an outer perimeter of the cap portion 430. In an aspect, the outer perimeter of the cap portion 430 may be greater than a diameter of the wall portion 432. A seat 437 is formed between the wall portion 432 and the outer edge 440 of the cap portion 430. The seat 437 may support the container 102 when the container 102 is coupled to the manifold assembly 400.

The manifold assembly 400 further includes three piercing members 450. In an alternate aspect, the manifold assembly 400 may include a single piercing member or at least two piercing members. The piercing members 450 may be coupled to the manifold head 402 along the inner edge 438 of the cap portion 430. In an aspect, each of the piercing members 450 may be spaced evenly along the inner edge 438. For example, if three piercing members are coupled to the manifold head 402, they may be spaced 120° apart about the inner edge 438.

The piercing members 450 may extend into a channel 446 formed by the wall portion 432, such that when a collapsible container is positioned within the channel 446, the piercing members 450 may engage and pierce the membrane of the container. Each of the piercing members 450 may include a base (not visible) and a tip 454 having a substantially similar configuration as the base 252 and the tip 254 of the piercing member 250.

The manifold assembly 500 includes a manifold head 502 having a first cap section 504, a second cap section 506, and a neck 508. The first cap section 504 may have a diameter larger than the second cap section 506, allowing for different sized containers 102 to be attached to the manifold assembly 500. Each of the first and second cap sections 504 and 506 may include a piercing member 550 coupled thereto in a way at least similar to how the piercing members 250, 350, and 450 are coupled to their respective manifold assemblies 200, 300, and 400.

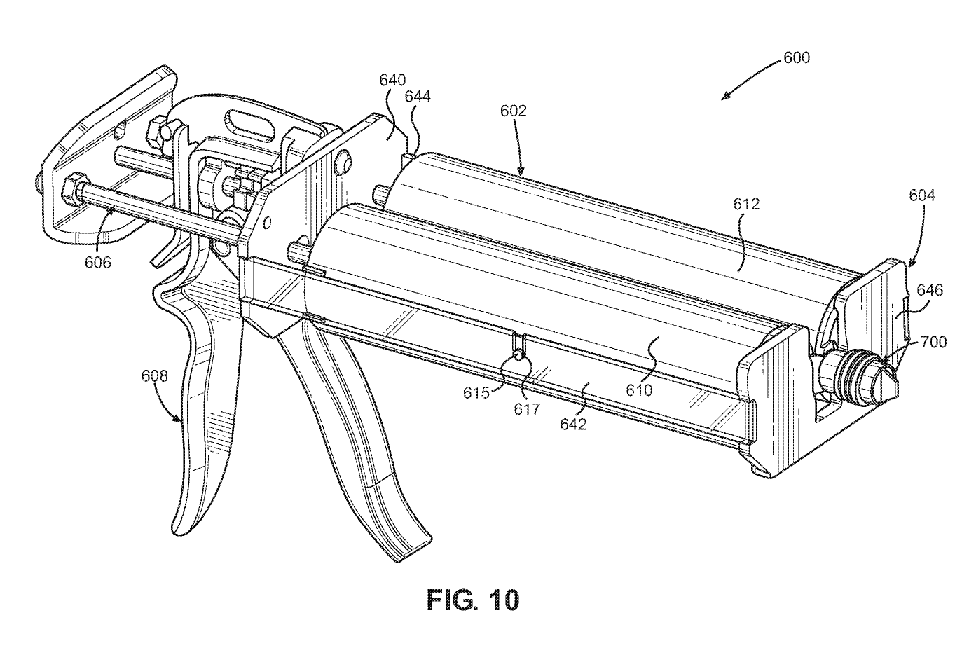

FIG. 10 illustrates a perspective view another aspect of a fluid dispensing assembly 600. The fluid dispensing assembly 600 includes containers 602, a support structure 604, a plunger assembly 606, an actuator 608, and a manifold assembly 700. The plunger assembly 606, the actuator 608, and the manifold assembly 700 may include any of the configurations described above related to the plunger assembly 106, the actuator 108, and the manifold assemblies 200, 300, 400, and 500, respectively.

The containers 602 may include cylindrical barrels 610 and 612. The barrels 610 and 612 may be configured substantially similarly to cylindrical barrels 110 and 112 of container 102 described above with the following additional features. The first and second cylindrical barrels 610 and 612 may include a first pin 615 and second pin (not visible), respectively, extending from an outer surface. The pins 615 may be cylindrical in shape and may be positioned between a proximal end and a distal end of each of the barrels 610 and 612. In an aspect, the pins 615 are positioned in a middle of the barrels 610 and 612.

The support structure 604 includes a base 640, a first extension arm 642, a second extension arm 644, and a gate 646. The base 640, the first extension arm 642, the second extension arm 644, and the gate 646 are configured substantially similarly to the base 140, the first extension arm 142, the second extension arm 144, and the gate 146 of the support structure 104, respectively, with the following additional features. The first and second extension arms 642 and 644 may define a first recess 617 and a second recess (not visible), respectively. Each recess 617 may be positioned between a proximal end and a distal end of their respective first and second extension arms 642 and 644.

Each recess 617 of the support structure 604 may be configured to receive each respective pin 615 of the first and second barrels 610 and 612. The pins 615 may slide into the recess 617 from a top of the support structure 604. When the pins 615 are positioned within the recesses 617, the first and second barrels 610 and 612 may pivot about the pins 615 causing the barrels 610 and 612 to rotate relative to the support structure 604.

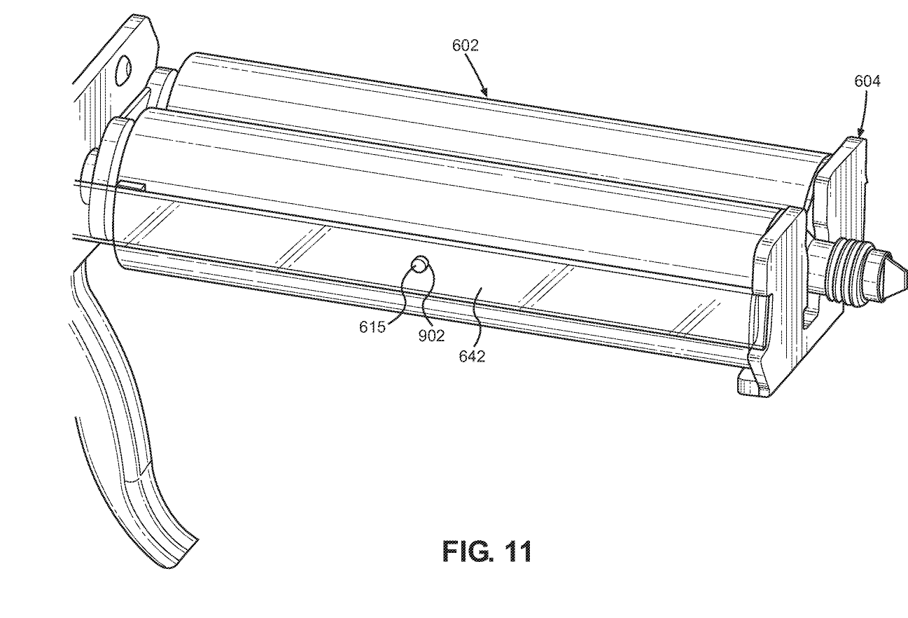

FIG. 11 illustrates an alternative structure for coupling the containers 102 to the support structure 604, according to an aspect of this disclosure. The first and second extension arms 642 and 644 may define a first pocket 902 and a second pocket (not visible), respectively. The pins 615 may snap into the pockets 902 forming a snap clip coupling.

In an aspect, a distance the pins 615 are located from the distal end of the barrels 610 and 612 is somewhat less than the distance the recesses 617 are located from the gate 646 at the distal end of the support structure 604. A benefit of the pin 615 and recess 617 couplings is that no force, or very minimal force, is applied to the pin 615 by the containers 602 when the plunger assembly 606 is providing a force to the collapsible containers within the containers 602. Instead, the force provided by the plunger assembly 606 is transferred to the first and second extension arms 642 and 644, the base 640, and the gate 646, such that the support structure 604 bears the load from the plunger assembly 606 as opposed to the pin 615 and recess 617 (or pin 615 and pocket 902) coupling.

Another benefit of the pin 615 and recess 617 (or pin 615 and pocket 902) coupling is that the containers 102 may be easily removed and replaced from the support structure 604 for, for example, cleaning or replacement.

The use of the fluid dispensing assemblies 100 and 600 is now described. Although reference is made to the fluid dispensing assembly 100, manifold assembly 200, and piercing member 250 in the below described example, it will be appreciated that this method may also be employed by either aspect of the fluid dispensing assemblies 100 and 600 having any of the aspects of the piercing members 250, 350, 350′, 450, and 550 coupled to the manifold assemblies 200, 300, 300′, 400, 500, and 700.

The fluid dispensing assemblies 100 may be provided in a partially disassemble state. For example, the fluid dispensing assembly 100 shown in FIGS. 1-3 may be provided with the actuator 108, the plunger assembly 106, and the support structure 104 coupled together, but without the containers 102 and manifold assembly 200 coupled thereto. Further, the manifold assembly 200 may not be provided coupled to the containers 102. Additionally, a protective cap (not shown) may be provided to cover the piercing member 250 within the manifold head 202. The protective cap may protect the piercing member 250 so that they are not damaged so that, for example, the manifold assembly 200 can be safely sold and transported without concern that the piercing member 250 would damage or be damaged by other components.

When it is desirable to pierce the membranes of the collapsible containers, the protective cap may be removed from the manifold assembly 200, and the containers 102 may be coupled to the manifold head 202. A nozzle (not shown) may be coupled to the neck 208 of the manifold head 202 via the thread portion 224. The collapsible containers may be inserted into the containers 102 and moved towards the distal end of the containers 102. After the collapsible containers are inserted into the containers 102, the manifold assembly 200 may be attached to the distal end of the containers 102. The containers may then be positioned within the support structure 604 and the plunger assembly 106 may be inserted into the containers 102. The actuator 108 may provide a force to the plunger assembly 106 moving the plunger assembly 106 in the distal direction forcing the collapsible containers to engage the piercing members 250, thereby causing the members 250 to pierce or puncture the collapsible containers. In particular, the piercing tip 254 of the piercing member 250 may engage and pierce the distal end of the collapsible container. Alternatively, the attachment of the manifold assembly 200 may cause the piercing members 250 to pierce or puncture the collapsible containers.

Once the collapsible containers are pierced, the fluids contained within the containers can be extracted to flow into the manifold head 202. In particular, the fluids flow through their respective first and second openings 210 and 212 of the first and second cap sections 204 and 206. The first and second openings 210 and 212 communicate with their respective first and second passageways 220 and 222 in the neck 208, and the fluids flow into these passageways. The fluids then flow through the first and second passageways 220 and 222 and into the nozzle and out of the manifold head 202. If a nozzle is coupled to the manifold head 202, then the fluids would flow into the nozzle from the manifold head 202.

When the collapsible containers are pierced, flaps 256 and 258 are cut into the collapsible containers and two opening are formed. The openings may be substantially the same size as the respective first and second openings 210 and 212 in the first and second cap sections 204 and 206. The flaps 256 and 258 may open into the first and second openings 210 and 212, such that the flaps 256 and 258 lie against sidewalls of the first and second openings 210 and 212. In an aspect, the flaps 256 and 258 may further extend to the first and second passageways 220 and 222, such that the flaps 256 and 258 at least partially lies against sidewalls of the first and second passageways 220 and 222. A benefit of the flaps 256 and 258 opening into the first and second openings 210 and 212 is that a large opening may be formed in the collapsible containers and the flaps 256 and 258 fold out of the flow path of the fluid contained in the collapsible containers.

Although reference has been made to the fluid dispensing assembly 100 having multiple containers 102 for receiving two collapsible containers, it will be appreciated that the teachings herein are also readily adaptable to a fluid dispensing assembly having a single container 102 for receiving a single collapsible container, or more than two containers 102 for receiving more than two collapsible containers. The manifold assembly 200 would be configured to receive one or multiple containers 102 and collapsible containers, and the piercing member 250 would be positioned as described above to pierce the membranes of the collapsible containers.

The fluid dispensing assemblies 100 and 600 may be used with various types of collapsible containers. For example, containers that have a pierceable component that must be pierced before fluid can be dispensed from the container (such as syringes, for example) can be used with the manifold assembly 200 in a manner consistent with the above.

It will be appreciated that the foregoing description provides examples of the disclosed system and method. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

What is claimed is:

1. A dispensing system, comprising:
a support structure, comprising:
a base,
an extension arm having a first end coupled to the base and a second end spaced from the first end, the extension arm defining a recess between the first end and the second end, and
a gate coupled to the second end of the extension arm; and
a container coupled to the support structure, the container having a pin extending from an outer surface,
wherein the recess is configured to receive the pin within.

2. The dispensing system of claim 1, wherein the extension arm is a first extension arm and the recess is a first recess, and wherein the container is a first container and the pin is a first pin, the dispensing system further comprising:
a second container coupled to the support structure, the second container having a second pin extending from an outer surface,
wherein the support structure further comprises:
a second extension arm having a first end coupled to the base and a second end coupled to the gate, the second extension arm defining a second recess between the first end and the second end, and
wherein the second recess is configured to receive the second pin within.

3. The dispensing system of claim 2, further comprising:
a plunger assembly having a first plunger and a second plunger, the first plunger configured to slide within the first container and the second plunger configured to slide within the second container.

4. The dispensing system of claim 1, further comprising:
a manifold head coupled to the container, and
at least one piercing member coupled to the manifold head, the at least one piercing member extending into the container.

5. The dispensing system of claim 1, wherein the recess is approximately in a middle of the extension arm between the first end the second end.

6. The dispensing system of claim 1, wherein the pin is in a middle of the container.

7. The dispensing system of claim 1, wherein the pin received within the recess comprises a snap clip coupling.

8. The dispensing system of claim 1, wherein the support structure further comprises a top portion and a bottom portion, wherein the recess opens towards the top portion, and wherein the container is received within the support structure by lowering the container into the support structure from the top portion towards the bottom portion.

9. A dispensing system, comprising:
a support structure, comprising:
a base,
an extension arm having a first end coupled to the base and a second end spaced from the first end, the extension arm defining a pocket between the first end and the second end, and
a gate coupled to the second end of the extension arm; and
a container coupled to the support structure, the container having a pin extending from an outer surface,
wherein the pocket is configured to receive the pin within.

10. The dispensing system of claim 9, wherein the extension arm is a first extension arm and the pocket is a first pocket, and wherein the container is a first container and the pin is a first pin, the dispensing system further comprising:
a second container coupled to the support structure, the second container having a second pin extending from an outer surface,
wherein the support structure further comprises:
a second extension arm having a first end coupled to the base and a second end coupled to the gate, the second extension arm defining a second pocket between the first end and the second end, and
wherein the second pocket is configured to receive the second pin within.

11. The dispensing system of claim 10, further comprising:
a plunger assembly having a first plunger and a second plunger, the first plunger configured to slide within the first container and the second plunger configured to slide within the second container.

12. The dispensing system of claim 9, further comprising:
a manifold head coupled to the container, and
at least one piercing member coupled to the manifold head, the at least one piercing member extending into the container.

13. The dispensing system of claim 9, wherein the pocket is approximately in a middle of the extension arm between the first end the second end.

14. The dispensing system of claim 9, wherein the pin is in a middle of the container.

15. A dispensing system, comprising:
a support structure, comprising:
a base,
an extension arm having a first end coupled to the base and a second end opposing the first end, and
a gate coupled to the second end of the extension arm; and
a container coupled to the support structure, the container including a rib extending along an outer surface of the container,
wherein the extension arm is configured to support the rib of the container.

16. The dispensing system of claim 15, wherein the container further including a retention rib extending along the outer surface, and wherein the container is configured to snap onto the extension arm.
